(19) United States
(12) Patent Application Publication
(10) Pub. No.: US 2011/0225264 A1
(43) Pub. Date: Sep. 15, 2011

(54) DATA COMMUNICATION METHOD

(75) Inventor: Isaac A Serar, Deer Park (AU)

(73) Assignee: BLUTRO PTY LTD, Delahey, Victoria (AU)

(21) Appl. No.: 13/054,777

(22) PCT Filed: Jul. 17, 2009
(86) PCT No.: PCT/AU09/00919

§ 371 Date: May 27, 2011

(30) Foreign Application Priority Data
Jul. 18, 2008 (AU) 2008903687
Sep. 19, 2008 (AU) 2008904891
Nov. 10, 2008 (AU) 2008905789
Jan. 9, 2009 (AU) 2009900050

(51) Int. Cl. G06F 15/173; G06F 15/16

(52) U.S. Cl. 709/217; 709/223; 709/224

(57) ABSTRACT

A data communication method, comprising: communicating first user data from a first computing device to a data storage; associating the first user data with an identifier of a portable user device; transmitting the identifier from the portable user device to a second computing device; and making a request in respect of the first user data at the second computing device based on the identifier.

### FIELD

The invention relates to a data communication method and a data communication system.

### BACKGROUND

Traditionally, documents and files are carried by people using carry bags such as briefcases and school bags. In many cases, it is required or desirable to have such documents at hand so that one may present one or more of such documents to others. For example, a student carries homework assignments in her school bag because she is required to hand in a particular assignment to one of her teachers. In a similar manner, a shopper presents his “rewards” card when making a purchase at a particular departmental store because he desires to accrue reward points.

Today, electronic devices are available for people to carry such documents. These include notebook computers, USB thumb-drives etc. These modern tools are unfortunately not ideal because they are often cumbersome and time consuming to use. For instance, to locate a particular document in a USB drive, a person has to manually select the appropriate folder containing the relevant document.

There is a need for an alternative data communication method.

### SUMMARY OF THE INVENTION

In a first aspect, the invention provides a data communication method, comprising:

communicating first user data from a first computing device to a data storage;

associating the first user data with an identifier of a portable user device;

transmitting the identifier from the portable user device to a second computing device; and

making a request in respect of the first user data at the second computing device based on the identifier.

In an embodiment, the request is for communication of the first user data from the data storage.

In an embodiment, the request is for communication of the first user data to the second computing device.

In an embodiment, the request is for a status of the first user data.

In an embodiment, the request made in respect of the first user data is performed by a second user.

In an embodiment, the first user data is communicated from the first computing device to the data storage via a first communications network.

In an embodiment, the first communications network is the internet and the first user data is uploaded from the first computing device to the data storage.

In an embodiment, the first user data is communicated from the data storage to the second computing device via a second communications network.

In an embodiment, the second communications network is a local area network and the first user data is copied from the data storage to the second computing device.

In an embodiment, the second communications network is the internet and the first user data is downloaded from the data storage to the second computing device

In an embodiment, the method further comprises checking the data storage to verify that the first user data was communicated from the first computing device to the data storage within a time period.

In an embodiment, the method further comprises:

associating the identifier with a first image of a user; and

authenticating the identifier transmitted from the portable user device based on the first image.

In an embodiment, the method further comprises:

modifying the first user data communicated from the data storage; and

communicating the first user data that has been modified from the second computing device to the data storage.

In an embodiment, the method further comprises transmitting information to the portable user device.

In an embodiment, the information transmitted to the portable user device comprises at least one of a group consisting of advertisements, promotional coupons and personal reminders.

In an embodiment, the first user data comprises at least one of a group consisting of: a user's school homework; a user's school e-files; a user's loyalty account details; a user's membership details; a user's pre-paid account details; and a user's gift-card details.

In an embodiment, the portable user device is a Bluetooth device and the identifier is a Bluetooth ID.

In an embodiment, the portable user device is a mobile phone.

In an embodiment, the method further comprises configuring the portable user device to enable transmission.

In an embodiment, the portable user device is adapted to be configured by a user of the portable user device.

In an embodiment, the identifier is transmitted from the portable user device to the second computing device according to a Wireless Personal Area Network (WPAN) standard.

In a second aspect, the invention provides a data communication method, comprising:

receiving a communication in respect of first user data from a first computing device;

storing data based on the first user data in association with an identifier of a portable user device;

receiving the identifier at a second computing device; and

making a request in respect of the first user data at the second computing device based on the identifier.

In an embodiment, the method further comprises storing the first user data in a data storage.

In an embodiment, the method further comprises storing the location of the first user data so it can be retrieved.

In an embodiment, the request is for communication of the first user data from the data storage.

In an embodiment, the request is for communication of the first user data to the second computing device.

In an embodiment, the request is for a status of the first user data.

In an embodiment, the request made in respect of the first user data is performed by a second user.

In an embodiment, the communication in respect of first user data is received from the first computing device via a first communications network.

In an embodiment, the first communications network is the internet and the first user data is uploaded from the first computing device to the data storage.

In an embodiment, the request in respect of first user data is made at the second computing device via a second communications network.

In an embodiment, the second communications network is a local area network and the first user data is copied to the second computing device.

In an embodiment, the second communications network is the internet and the first user data is downloaded at the second computing device

In an embodiment, the method further comprises checking to verify that the communication in respect of first data was received from the first computing device within a time period.

In an embodiment, the method further comprises:

associating the identifier with a first image of a user; and

authenticating the identifier received at the second computing device based on the first image.

In an embodiment, the method further comprises:

modifying the first user data communicated to the second computing device; and

communicating the first user data that has been modified from the second computing device to a data storage.

In an embodiment, the method further comprises transmitting information to the portable user device.

In an embodiment, the information transmitted to the portable user device comprises at least one of a group consisting of advertisements, promotional coupons and personal reminders.

In an embodiment, the first user data comprises at least one of a group consisting of: a user's school homework; a user's school e-files; a user's loyalty account details; a user's membership details; a user's pre-paid account details; and a user's gift-card details.

In an embodiment, the portable user device is a Bluetooth device and the identifier is a Bluetooth ID.

In an embodiment, the portable user device is a mobile phone.

In an embodiment, the identifier is received at the second computing device according to a Wireless Personal Area Network (WPAN) standard.

In a third aspect, the invention provides a data communication system, comprising:

a data controller for receiving a communication in respect of first user data from a first computing device, and storing data based on the first user data in association with an identifier of a portable user device;

a second computing device comprising:

(i) an identifier receiver for receiving the identifier, and

(ii) a data requester for making a request in respect of the first user data based on the identifier.

In an embodiment, the system further comprises a data storage for storing the first user data.

In an embodiment, the data controller stores the location of the first user data so it can be retrieved.

In an embodiment, the data requester makes a request in response to receipt of the identifier.

In an embodiment, the request is for communication of the first user data from the data storage.

In an embodiment, the request is for communication of the first user data to the second computing device.

In an embodiment, the request is for a status of the first user data.

In an embodiment, the data requester is further arranged to allow a second user to make the request.

In an embodiment, the communication in respect of first user data is received from the first computing device via a first communications network.

In an embodiment, the first communications network is the internet and the first user data is uploaded from the first computing device to a data storage.

In an embodiment, the data controller is further arranged to request in respect of first user data via a second communications network.

In an embodiment, the second communications network is a local area network and the first user data is copied to the second computing device.

In an embodiment, the second communications network is the internet and the first user data is downloaded at the second computing device

In an embodiment, the data controller is further arranged to check and verify that the communication in respect of first data was received from the first computing device within a time period.

In an embodiment, the data controller is further arranged to associate the identifier with a first image of a user, and the second computing device further comprises an identifier authenticator for authenticating the identifier received at the second computing device based on the first image.

In an embodiment, the second computing device further comprises a second data controller for modifying the first user data communicated to the second computing device, and communicating the first user data that has been modified from the second computing device to a data storage.

In an embodiment, the data controller is further arranged to transmit information to the portable user device.

In an embodiment, the information transmitted to the portable user device comprises at least one of a group consisting of advertisements, promotional coupons and personal reminders.

In an embodiment, the first user data comprises at least one of a group consisting of: a user's school homework; a user's school e-files; a user's loyalty account details; a user's membership details; a user's pre-paid account details; and a user's gift-card details.

In an embodiment, the portable user device is a Bluetooth device and the identifier is a Bluetooth ID.

In an embodiment, the portable user device is a mobile phone.

In an embodiment, the identifier is received at the second computing device according to a Wireless Personal Area Network (WPAN) standard.

In a fourth aspect, the invention provides computer program code which when executed implements any one of the above method.

In a fifth aspect, the invention provides a computer readable storage medium comprising the above computer code.

### BRIEF DESCRIPTION OF THE DRAWINGS

The present invention is described further by way of example with reference to the accompanying drawings, in which:

FIG. 1 is a flow chart of an embodiment of the data communication method;

FIG. 2 is a flow chart of an embodiment of the data communication method from the second computing device's perspective;

FIG. 3 is a schematic diagram of an embodiment of the data communication system;

FIG. 4 is a schematic diagram illustrating additional components of the teacher's computer;

FIG. 5 is a schematic diagram of another embodiment of the data communication system;

FIG. 6 is a flow chart illustrating the user registration process;

FIG. 7 is a schematic diagram illustrating the information stored in respect of a member;

FIG. 8 is a schematic diagram illustrating the components of the POS Terminal of FIG. 5; and

FIG. 9 is a flow chart illustrating process of communicating loyalty program information using a member's Bluetooth Medium Access Control (MAC) Address.

### DETAILED DESCRIPTION

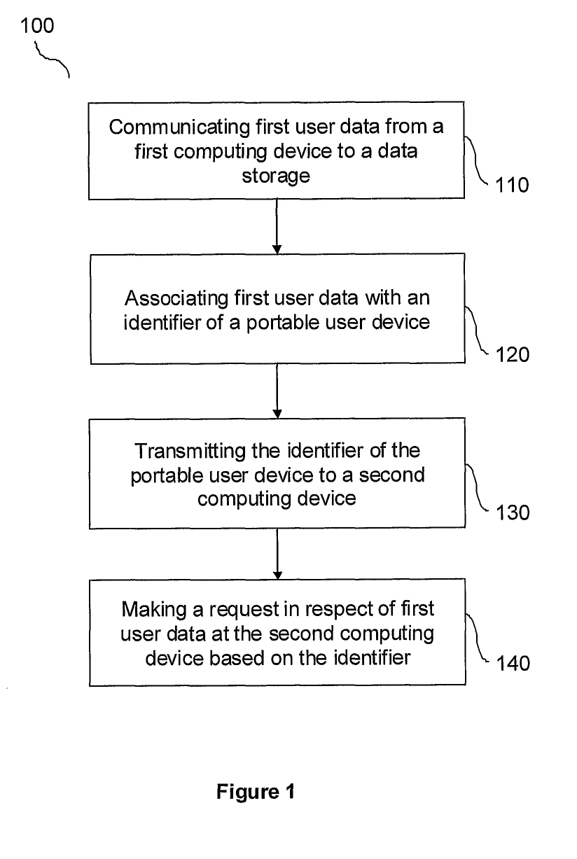

FIG. 1 broadly summarizes the method of an embodiment of the data communication method 100 in a flow chart. As a first step, first user data is communicated from a first computing device to a data storage 110. Typically, the first computing device is a computer having a Bluetooth module (such as a Bluetooth USB adaptor or a built-in Bluetooth network card). Depending on the application of the data communication method, first user data may be the first user's school homework, the first user's school e-files, the first user's loyalty account details, the first user's membership details, the first user's pre-paid account details, the first user's gift-card details etc. Typically, the communication of first user data from the first computing device to the data storage is via a first communications network such as the internet and the first user data is uploaded from the first computing device to a data storage.

The first user data is then associated with an identifier of a portable user device 120. This allows identification of the first user data by the identifier of a portable user device. Typically, the portable user device is a mobile phone and the identifier is a Bluetooth ID. In some cases, it might be desirable to authenticate the identifier. For example, if the first user data is to be accessed by someone who does not know the first user. One way of enabling authentication is to associate a first image of a user with the identifier. In this way, a second user can authenticate the presence of the first user not only by the identifier of the portable user device but also by matching the first image with an actual person.

To access the first user data, the identifier from the portable user device is transmitted to a second computing device 130. Typically, this transmission is effected according to a Bluetooth standard (sometimes referred to as IEEE Standard 802.15x). For portable user devices such as mobile phones, transmission is effected by having a user configure the phone to enable Bluetooth transmission. Persons skilled in the art however will appreciate that transmission may be effected using any another Wireless Personal Area Network (WPAN) standard. It is envisaged that the identifier may be a Bluetooth ID (such as a Bluetooth MAC Address), an IP Address or a portable user device serial number.

Once the identifier has been transmitted to the second computing device, a request in respect of the first user data can be made at the second computing device based on the identifier 140. In most cases, the request is for communication of the first data from the data storage to the second computing device. This however need not be the case; it is envisaged that the request need not be for communication of the first user data but simply a request for a status of the first user data. In addition, the first user data may be modified at the second computing device and subsequently be communicated back from the second computing device to the data storage to update the first user data.

Furthermore, if a user is making a request for communication of the first data, the request can be made for communication of the first user data to another computing device that is not the second computing device.

Also, the user making the request may not be the first user, it is envisaged that a second user might be making the request in respect of the first user data at the second computing device. For example, a second user may make a request to check the data storage to verify that the first user data was communicated from the first computing device to the data storage within a time period previously prescribed. Persons skilled in the art will appreciate that any communication or user data may be also collected by third party organizations.

Typically, the communication to the second computing device or to another computing device is via a second communications network. In an embodiment, this second communications network is a local area network and the first user data is copied from the data storage. In another embodiment, this second communications network is a Virtual Private Network (VPN) allowing communication over both a local area network and the internet and the first user data is downloaded via this VPN from the data storage. Persons skilled in the art will appreciate that the first and second communications network can be the same network. For example, communication can be both via the internet.

Finally, after making a request in respect of the first user data at the second computing device, information may also be transmitted to the portable user device. Typically, this information may include advertisements, promotional coupons and personal reminders. It is envisaged that the information may also be tailored for particular users depending on the content of the first user data or where an identifier is received. In addition, it is also envisaged that the second computing device may be connected to display devices remote from the second computing device; for example, a LCD display may be positioned remotely from a second computing device at an aisle in a supermarket so as to conveniently display goods that the user is likely to desire when the user walks down the aisle.

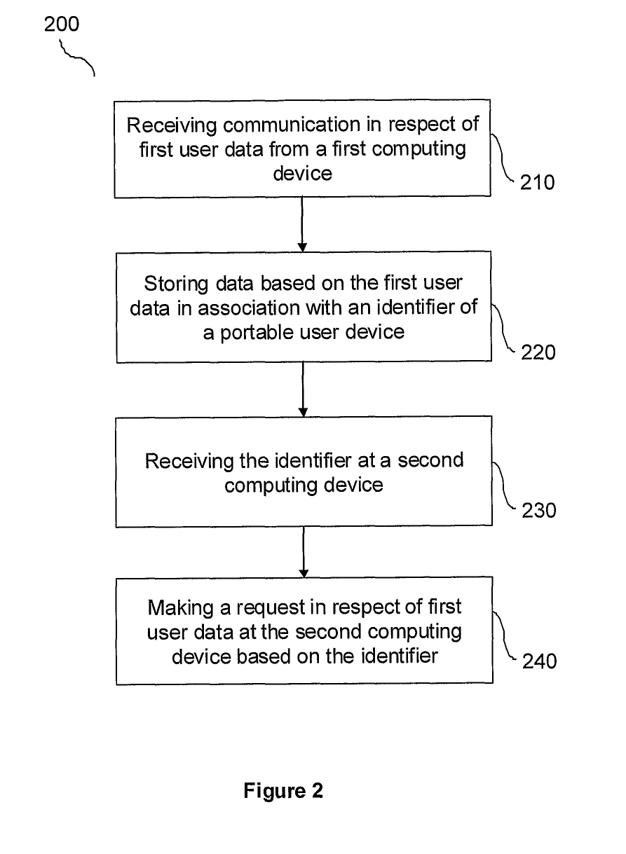

FIG. 2 is a flow chart illustrating the step performed by the second computing device according to an embodiment.

First, a communication in respect of first user data is received from a first computing device 210. Then data based on the first user data in association with an identifier of a portable user device is stored 220. At a second computing device, the identifier is received 230. Based on the identifier, a request in respect of the first user data is then made at the second computing 240.

Persons skilled in the art will appreciate that embodiments of the data communication method can be implemented or provided as a system in a variety of ways including as software, hardware, firmware, or as a combination of these. In addition, individual components arranged to implement a step of the system (such as particular modules) do not need to all be provided in the same manner. It should also be noted that the system may be distributed, including by being located in a plurality of countries.

Typically, it is envisaged that software program code is executed on a plurality of computing devices to implement the data communication method, each computing device comprising hardware such as a processor, a hard disk, a portable user device interface, a network interface etc. For example, key components of the data communication method can be provided by installing software program products on two computing devices: (i) a processor in the first computing device executes a software program installed on a hard disk, receives transmission via a portable user device interface from the portable user device, and uploads user data to the data storage connected via a network interface; and (ii) a processor in the second computing device executes a software program installed in the second computing system's hard disk, receives transmission via the second computing system's portable user device interface from the portable user device, and downloads user data at the second computing system via the second computing system's network interface.

### First Exemplary Embodiment

### A Bluetooth Virtual Briefcase for Students

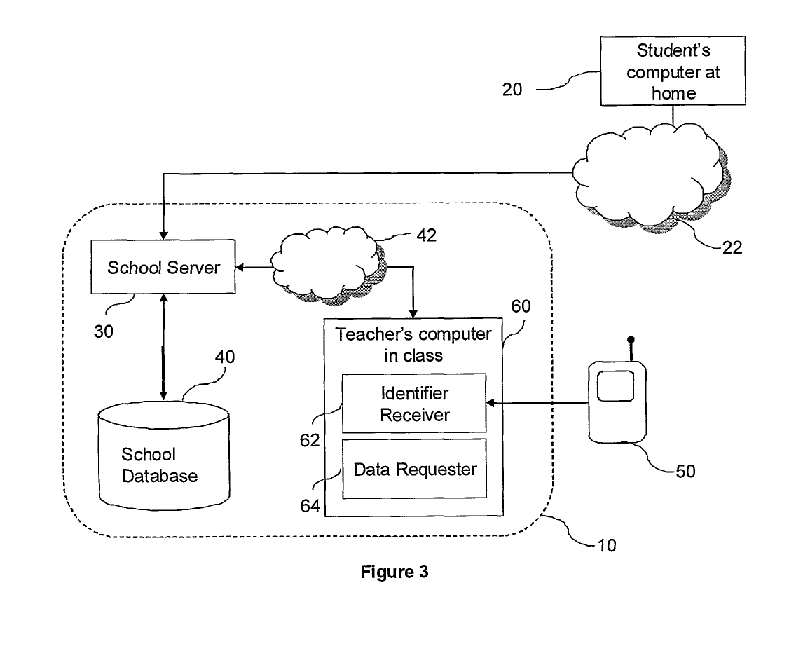

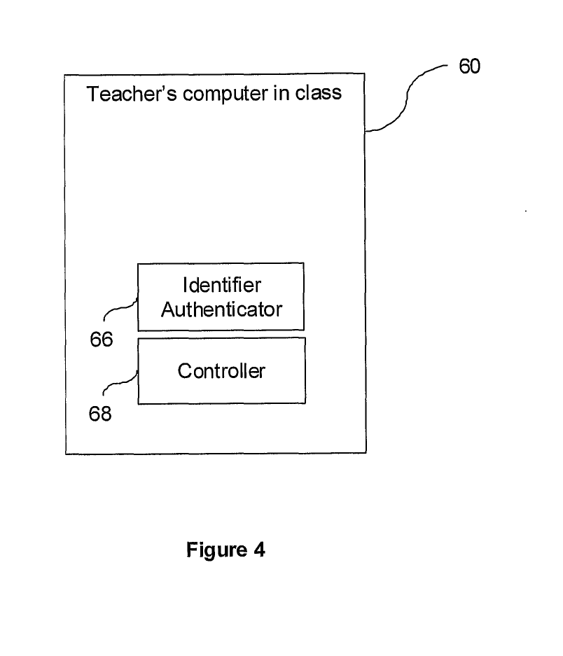

FIGS. 3 and 4 are schematic diagrams of an embodiment of data communication system. Referring first to FIG. 3, the data communication system 10 comprises a second computing device 60 and a data controller 30. In this embodiment, the second computing device is a teacher's computer in a classroom and the data controller is implemented on a school server. The teacher's computer 60 comprises an identifier receiver 62 and a data requester 64.

The school server 30 is arranged to receive a communication in respect of first user data from a first computing device 20, and storing data based on the first user data in association with an identifier of a portable user device 50. In this embodiment, the first user is typically a student, the first user data is the student's homework assignments and the first computing device is the student's computer at home. The portable user device is the student's mobile phone 50 and the identifier is a Bluetooth ID of the mobile phone.

Persons skilled in the art will appreciate that a student's homework assignment(s) may be associated with a Bluetooth ID of the student's mobile phone in a variety of ways. For example, a student may associate a Bluetooth ID with a school account during a once-off registration process for the school account; this is done simply by placing a Bluetooth enabled mobile phone within the vicinity of where registration takes place. This will then allow the student to login to the school account at the student's home computer and attach any homework assignment which the student wish to associate with the Bluetooth ID.

The identifier receiver 62 is arranged to receive the identifier of the portable user device. That is, the identifier receiver 62 is arranged to receive the Bluetooth ID from the student's mobile phone 50. The data requester 64 is arranged to make a request in respect of the student's homework assignments based on the received Bluetooth ID.

In this embodiment, the teacher's computer 60 is arranged to make request for the student's homework assignments via a Virtual Private Network (VPN) 42. The teacher's computer 60 is further arranged to check and verify that the communication in respect of the student's homework assignments was received from the student's computer 20 was within a time period.

Also, the data requester 64 is further arranged to make a request for communication of the student's homework from the data storage 40 to the teacher's computer 60.

In use, the school server 30 first receives a communication in respect of a student's homework assignments from the student's computer at home 20. Typically, this is a communication of the student's homework assignments from the student's computer at home 20 to the school database 40. In this embodiment, the school database is part of the data communication system in this embodiment. However, it is envisaged that in an alternative embodiment, the school database is not part of the data communication system and is located remotely or the school server is adapted to receive data from any nominated data storage—for example, a web server maintained by a third party. In this embodiment, communication in respect of student's homework assignments is received from the student's computer at home 20 via the internet 22.

After communication in respect of student's homework assignments is received, the school server 30 stores data based on the student's homework assignments in association with the Bluetooth ID of the student's mobile phone 50. This allows the school server 30 to access the student's homework assignments by using the Bluetooth ID associated with the student's homework assignments. In this embodiment, the data stored by the school server 30 is the location of the student's homework assignments so it can be retrieved.

To access the student's homework assignments, an identifier receiver 62 at the teacher's computer 60 receives the Bluetooth ID associated with the student's homework assignments. It is envisaged that the identifier receiver 62 typically detects for Bluetooth ID periodically or is arranged to automatically detect for Bluetooth IDs at a prescribed time—for example, five minutes after the start of a class. Then the data requester 64 makes a request in respect of the student's homework assignments based on the received Bluetooth ID. It is envisaged that in certain situations, the data requester 64 makes a request in respect of student's homework assignments automatically once the Bluetooth ID is received.

FIG. 4 illustrates schematically some additional components which may be used together with the embodiment of FIG. 3. For example, the school server 30 may be further arranged to associate a Bluetooth ID with a photograph of a student, and the teacher's computer 60 may further comprise an identifier authenticator 66 arranged to enable authentication of the Bluetooth ID received at the teacher's computer 60 based on the photograph. In this embodiment, the identifier authenticator 66 pops up a photograph of a student when a Bluetooth ID is received at the teacher's computer 60. This allows a teacher to easily authenticate a student's presence in class by matching the photograph in the teacher's computer with a student in class even if the teacher does not know the student (for example, if the teacher is a substitute teacher).

Furthermore, the teacher's computer 60 may further comprise a controller 68 arranged to modify the student's homework assignments that has been communicated to the teacher's computer 60 or to add more user data (such as requests for new homework assignments etc). This controller 68 is also arranged to communicate the student's homework assignments that has been modified from the teacher's computer 60 back to the school database 40. This allows a teacher to update the student's homework assignments with comments, mark-ups and/or grades, and it also allows a student to get access to these updated homework assignments at home.

Finally it is also envisaged that backup systems (including means for using a key card having a barcode number etc) may also be provided in case the student's mobile phone 50 is not operable (for instance, if the mobile phone 50 runs out of battery or is malfunctioning).

### Second Exemplary Embodiment

### A Bluetooth Virtual Wallet for Shoppers

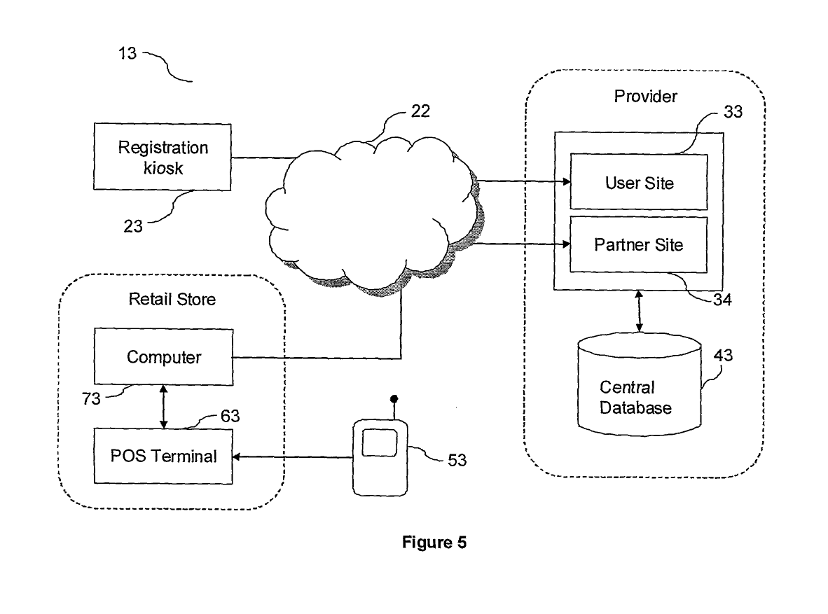

FIGS. 5 to 9 illustrate another embodiment of the data communication system. Referring first to FIG. 5, there is illustrated in this embodiment a first computing device in the form of a registration kiosk 23. Typically, the registration kiosk is a computing system available in an open area of a shopping mall having various retail stores. The registration kiosk 23 is arranged to connect via the internet 22 to a data communication system provider's user site 33. The registration kiosk 23 is arranged to receive a Bluetooth MAC Address from a user's mobile phone 53.

In addition to registration kiosk 23, the system comprises a computer 73 and a second computing device in the form of a Point of Sale (POS) Terminal 63 at a retail store. The computer 73 serves as a gateway for obtaining data required by the POS Terminal 63 via the internet 22. The POS Terminal 63 is arranged to perform POS transactions and is arranged to detect Bluetooth MAC Addresses from Bluetooth devices within the retail store.

The system also comprises at the data communication system provider a central database 43 and a computing system hosting a user website 33 and a partner website 34. The user website 33 is arranged to allow user's to register as a member of the data communication system 13 and also to allow a user to upload any user data to the central database. The partner website 34 is arranged to sign up third party organizations like the retail store for accessing user data stored in the central database 43. The computing system is arranged to communicate data gathered via the user website 33 and the partner website 34 to the central database 43.

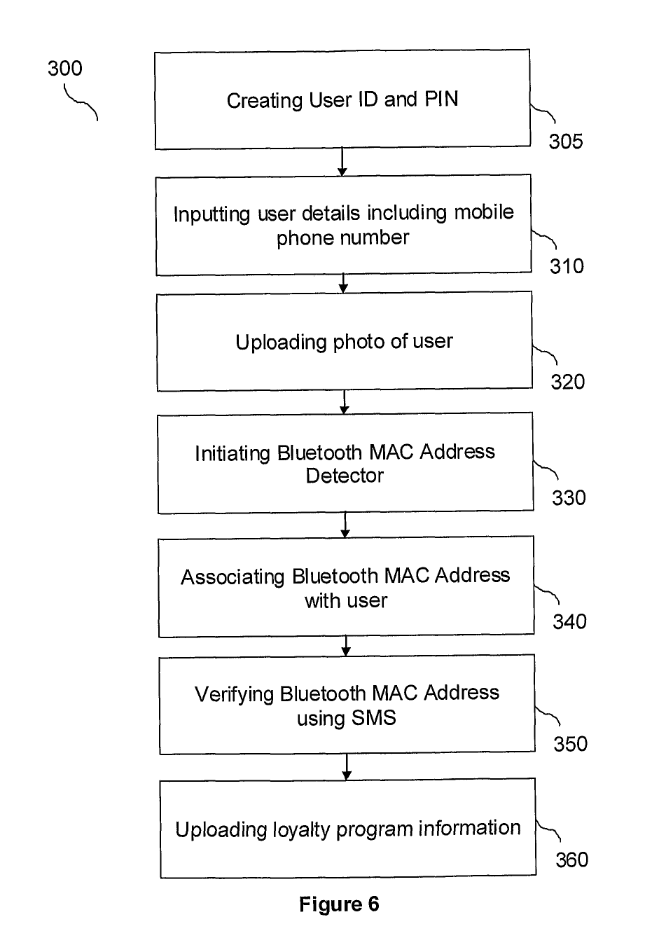

FIG. 6 is a flow chart summarizing how a user may register as a member of the data communication system 13 by accessing the user website 33 using the registration kiosk 23. First, the user creates a User ID and PIN 305. Persons skilled in the art will appreciate that Biometrics or key cards (having for example barcodes etc) can be used instead of a PIN. Next the user input details including his or her mobile phone number 310. A photograph of the user is then uploaded from the registration kiosk via the internet to the central database 320. It is envisaged that the registration kiosk may comprise means for creating a photograph of a user.

A Bluetooth MAC Address Detector is then initiated to detect the Bluetooth MAC Address of a user 330. Typically, this is by way of a web applet. A detected Bluetooth MAC Address is then associated with the user 340. To verify that the correct Bluetooth MAC Address has been detected, a Short Messaging Service (SMS) message is sent to the mobile phone 350. After it has been verified that the correct Bluetooth MAC Address has been detected, a user then uploads any loyalty program information 360. This loyalty program information together with other information obtained during registration is then communicated via the internet 22 to a central database 43.

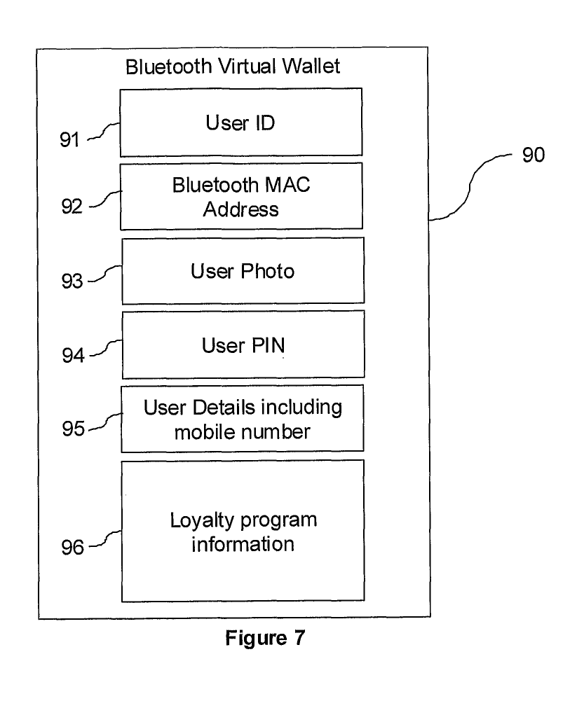

FIG. 7 is a schematic diagram illustrating a “Bluetooth Virtual Wallet” comprising the information relating to a registered member that is stored in the central database 43. A member's information comprises a user ID 91, a Bluetooth MAC Address 92, a photograph of a user 93, a user PIN 94, user details including mobile phone number 95, and loyalty program information 96. It is envisaged that other information relating to the member may also be stored in the central database 43 such as favourite brands, wanted products, interests etc. This other information may be inputted by the member or be otherwise derived from a member's use of the data communication system.

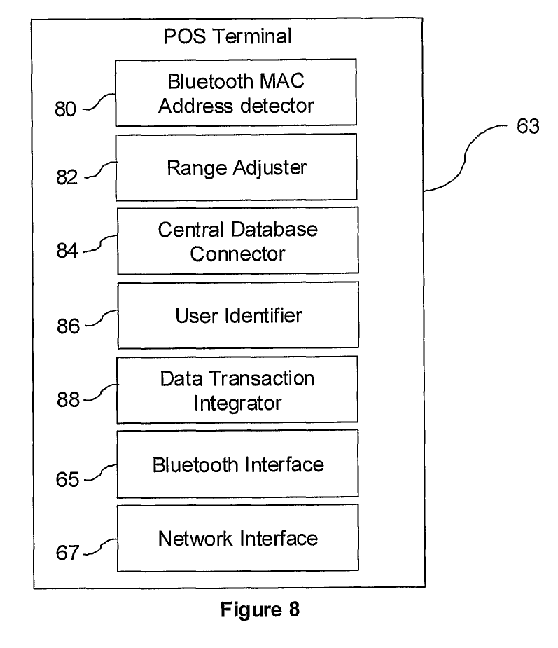

Turning now to FIG. 8, there is illustrated in greater detail the POS Terminal 63 of FIG. 5. First, the POS Terminal comprises a Bluetooth Interface 65 arranged to detect Bluetooth MAC Addresses, and a Network Interface 67 arranged to communicate with the internet.

In addition, the POS Terminal 63 also comprises several software modules including a Bluetooth MAC Address detector 80 arranged to detect the MAC Addresses of Bluetooth devices within the retail store, a Range Adjuster 82 arranged to adjust the range of detection for example, to just detect for Bluetooth MAC Addresses close to the POS Terminal, a Central Database Connector 84 arranged to communicate with the central database 43 via the computer 73, a User Identifier 86 arranged to identify registered users based on their respective mobile MAC address, and a Data Transaction Integrator 88 arranged to integrate with a POS transaction system to facilitate any exchange of information or data between the POS Terminal and any POS transaction system.

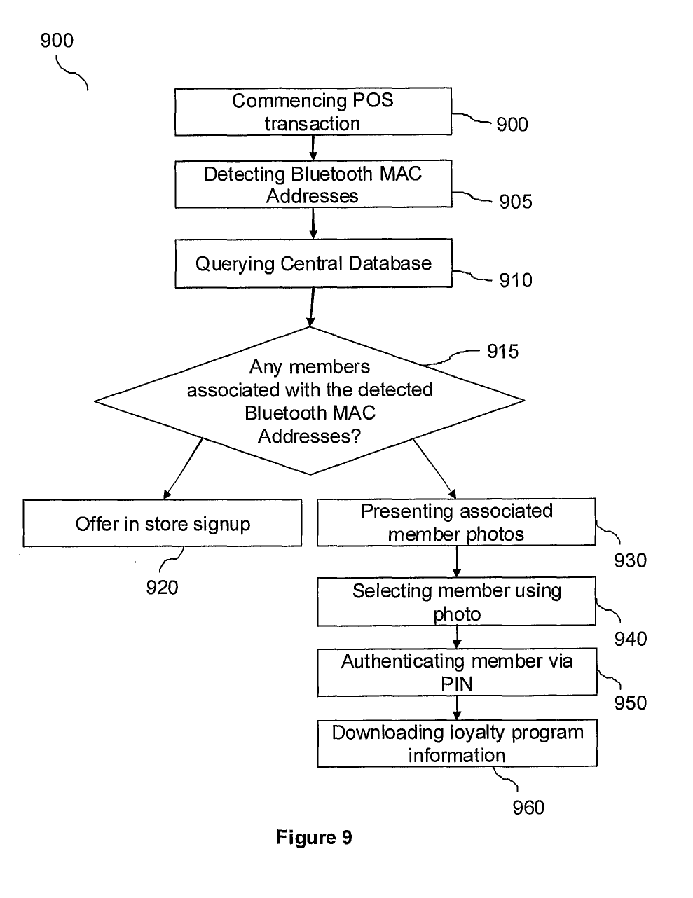

FIG. 9 is a flow chart illustrating the process of communicating loyalty program information using a member's Bluetooth MAC Address.

The process starts when a member commences a transaction at a POS Terminal registered for use with the data communication system 900. First an operator of the POS Terminal detects for Bluetooth MAC Addresses in the vicinity 905. Next the POS Terminal queries the central database based on at least one of the detected Bluetooth MAC Addresses 910. If none of the detected Bluetooth MAC Addresses is associated with any of the Bluetooth MAC Addresses of members of the system, an offer is made at the POS Terminal to the customer to signup to use the data communication system. If more than one of the detected MAC Addresses is associated with members of the system, a photograph associated with each Bluetooth MAC Address is presented to the operator 930. The operator then determines the appropriate member information by matching the customer with a photo of the member stored in the central database 940. To complete the transaction, the customer then enters a PIN to verify that he is indeed a member of the system 950. User data such as loyalty program information is then downloaded to the POS Terminal 960.

### Examples of Further Applications

Besides the embodiments described earlier, one or more of the embodiments of the invention can also be applied to various aspects of the Hospitality industry, the Security industry, the Transportation industry etc. In addition, it is envisaged that embodiments can also be used for providing Government service (including Social Security and Medical care).

### Advantages

An advantage of one or more of the embodiments of the invention is that is it reduces time and effort required by a user at a computing device to make a request for first user data in a data storage. This is advantageous in situations where it is not desirable or needed for users to spend large amount of time identifying themselves (such as to swipe a card, or to input a user login) or to select data.

Another advantage is that information tailored to a user can be transmitted to the user depending on the location of the user.

Another advantage is that a second user can authenticate a first user's presence using an image of the first user even if the second user does not know the first user.

### Variations

It will be understood to persons skilled in the art that many modifications may be made to the above embodiments, in particular features of various embodiments and examples may be combined to form further embodiments.

Further aspects of the data communication method will be apparent from the above description of the embodiments of data communication system. Persons skilled in the art will also appreciate that the data communication system could be embodied in program code. The program code could be supplied in a number of ways, for example in one or more software program products each including computer readable storage medium, such as a disc or a memory; or as a data signal (for example, by transmitting it from a server). For example, the data communication system can be provided by two software program products: (i) a first software program product comprising programming code adapted to be executed on a first computing device so that a software program for communicating user data from the first computing device to a data storage is installed on the first computing device; and (ii) a second software program product comprising programming code adapted to be executed on a second computing device so that a software program for making a request in respect of the user data based on an identifier from a portable user device is installed on the second computing device.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, the reference to any prior art publications herein does not constitute an admission that the publication forms a part of the common general knowledge in the art.

1. A data communication method, comprising:
communicating first user data from a first computing device to a data storage;
associating the first user data with an identifier of a portable user device, the identifier being adapted to be transmitted unprompted by the portable user device;
transmitting the identifier from the portable user device to a second computing device without being prompted by the second computing device; and
making a request in respect of the first user data at the second computing device based on the identifier.

2. A method as claimed in claim 1, wherein the request is for communication of the first user data from the data storage.

3. A method as claimed in claim 1, wherein the request is for communication of the first user data to the second computing device.

4. A method as claimed in claim 1, wherein the request is for a status of the first user data.

5. A method as claimed in claim 1, wherein the request made in respect of the first user data is performed by a second user.

6. A method as claimed in claim 1, wherein the first user data is communicated from the first computing device to the data storage via a first communications network.

7. A method as claimed in claim 6, wherein the first communications network is the internet and the first user data is uploaded from the first computing device to the data storage.

8. A method as claimed in claim 1, wherein the first user data is communicated from the data storage to the second computing device via a second communications network.

9. A method as claimed in claim 8, wherein the second communications network is a local area network and the first user data is copied from the data storage to the second computing device.

10. A method as claimed in claim 8, wherein the second communications network is the internet and the first user data is downloaded from the data storage to the second computing device.

11. A method as claimed in claim 1, further comprising checking the data storage to verify that the first user data was communicated from the first computing device to the data storage within a time period.

12. A method as claimed in claim 1, further comprising:
associating the identifier with a first image of a user; and
authenticating the identifier transmitted from the portable user device based on the first image.

13. A method as claimed in claim 8, further comprising:
modifying the first user data communicated from the data storage; and
communicating the first user data that has been modified from the second computing device to the data storage.

14. A method as claimed in claim 1, further comprising transmitting information to the portable user device.

15. A method as claimed in claim 14, wherein the information transmitted to the portable user device comprises at least one of a group consisting of advertisements, promotional coupons and personal reminders.

16. A method as claimed in claim 1, wherein the first user data comprises at least one of a group consisting of: a user's school homework; a user's school e-files; a user's loyalty account details; a user's membership details; a user's pre-paid account details; and a user's gift-card details.

17. A method as claimed in claim 1, wherein the portable user device is a Bluetooth device and the identifier is a Bluetooth ID.

18. A method as claimed in claim 1, wherein the portable user device is a mobile phone.

19. A method as claimed in claim 1, further comprising configuring the portable user device to enable transmission.

20. A method as claimed in claim 19, wherein the portable user device is adapted to be configured by a user of the portable user device.

21. A method as claimed in claim 1, wherein the identifier is transmitted from the portable user device to the second computing device according to a Wireless Personal Area Network (WPAN) standard.

22. A data communication method, comprising:
receiving a communication in respect of first user data from a first computing device;
storing data based on the first user data in association with an identifier of a portable user device, the identifier being adapted to be transmitted unprompted by the portable user device;
receiving a transmission of the identifier at a second computing device, the transmission not being prompted by the second computing device; and
making a request in respect of the first user data at the second computing device based on the identifier.

23. A method as claimed in claim 22, further comprising storing the first user data in a data storage.

24. A method as claimed in claim 22, further comprising storing the location of the first user data so it can be retrieved.

25. A method as claimed in claim 23, wherein the request is for communication of the first user data from the data storage.

26. A method as claimed in claim 22, wherein the request is for communication of the first user data to the second computing device.

27. A method as claimed in claim 22, wherein the request is for a status of the first user data.

28. A method as claimed in claim 22, wherein the request made in respect of the first user data is performed by a second user.

29. A method as claimed in claim 22, wherein the communication in respect of first user data is received from the first computing device via a first communications network.

30. A method as claimed in claim 29, wherein the first communications network is the internet and the first user data is uploaded from the first computing device to the data storage.

31. A method as claimed in claim 22, wherein the request in respect of first user data is made at the second computing device via a second communications network.

32. A method as claimed in claim 31, wherein the second communications network is a local area network and the first user data is copied to the second computing device.

33. A method as claimed in claim 31, wherein the second communications network is the internet and the first user data is downloaded at the second computing device

34. A method as claimed in claim 22, further comprising checking to verify that the communication in respect of first data was received from the first computing device within a time period.

35. A method as claimed in claim 22, further comprising:
associating the identifier with a first image of a user; and
authenticating the identifier received at the second computing device based on the first image.

36. A method as claimed in claim 31, further comprising:
modifying the first user data communicated to the second computing device; and
communicating the first user data that has been modified from the second computing device to a data storage.

37. A method as claimed in claim 22, further comprising transmitting information to the portable user device.

38. A method as claimed in claim 37, wherein the information transmitted to the portable user device comprises at least one of a group consisting of advertisements, promotional coupons and personal reminders.

39. A method as claimed in claim 22, wherein the first user data comprises at least one of a group consisting of: a user's school homework; a user's school e-files; a user's loyalty account details; a user's membership details; a user's pre-paid account details; and a user's gift-card details.

40. A method as claimed in claim 22, wherein the portable user device is a Bluetooth device and the identifier is a Bluetooth ID.

41. A method as claimed in claim 22, wherein the portable user device is a mobile phone.

42. A method as claimed in claim 22, wherein the identifier is received at the second computing device according to a Wireless Personal Area Network (WPAN) standard.

43. A data communication system, comprising:
a data controller for receiving a communication in respect of first user data from a first computing device, and storing data based on the first user data in association with an identifier of a portable user device, the identifier being adapted to be transmitted unprompted by the portable user device;
a second computing device comprising:
(i) an identifier receiver for receiving a transmission of the identifier, the transmission not being prompted by the second computing device; and
(ii) a data requester for making a request in respect of the first user data based on the identifier.

44. A system as claimed in claim 43, further comprising a data storage for storing the first user data.

45. A system as claimed in claim 43, wherein the data controller stores the location of the first user data so it can be retrieved.

46. A system as claimed in claim 43, wherein the data requester makes a request in response to receipt of the identifier.

47. A system as claimed in claim 44, wherein the request is for communication of the first user data from the data storage.

48. A system as claimed in claim 43, wherein the request is for communication of the first user data to the second computing device.

49. A system as claimed in claim 43, wherein the request is for a status of the first user data.

50. A system as claimed in claim 43, wherein the data requester is further arranged to allow a second user to make the request.

51. A system as claimed in claim 43, wherein the communication in respect of first user data is received from the first computing device via a first communications network.

52. A system as claimed in claim 51, wherein the first communications network is the internet and the first user data is uploaded from the first computing device to a data storage.

53. A system as claimed in claim 43, wherein the data controller is further arranged to request in respect of first user data via a second communications network.

54. A system as claimed in claim 53, wherein the second communications network is a local area network and the first user data is copied to the second computing device.

55. A system as claimed in claim 53, wherein the second communications network is the internet and the first user data is downloaded at the second computing device

56. A system as claimed in claim 43, wherein the data controller is further arranged to check and verify that the communication in respect of first data was received from the first computing device within a time period.

57. A system as claimed in claim 43, wherein the data controller is further arranged to associate the identifier with a first image of a user, and the second computing device further comprises an identifier authenticator for authenticating the identifier received at the second computing device based on the first image.

58. A system as claimed in claim 53, wherein the second computing device further comprises a second data controller for modifying the first user data communicated to the second computing device, and communicating the first user data that has been modified from the second computing device to a data storage.

59. A system as claimed in claim 43, wherein the data controller is further arranged to transmit information to the portable user device.

60. A system as claimed in claim 37, wherein the information transmitted to the portable user device comprises at least one of a group consisting of advertisements, promotional coupons and personal reminders.

61. A system as claimed in claim 43, wherein the first user data comprises at least one of a group consisting of: a user's school homework; a user's school e-files; a user's loyalty account details; a user's membership details; a user's pre-paid account details; and a user's gift-card details.

62. A system as claimed in claim 43, wherein the portable user device is a Bluetooth device and the identifier is a Bluetooth ID.

63. A system as claimed in claim 43, wherein the portable user device is a mobile phone.

64. A system as claimed in claim 43, wherein the identifier is received at the second computing device according to a Wireless Personal Area Network (WPAN) standard.

65. Computer program code which when executed implements the method in claim 1.

66. A computer readable storage medium comprising the computer code of claim 65.
